(19) United States
(12) Patent Application Publication
(10) Pub. No.: US 2019/0075752 A1
(43) Pub. Date: Mar. 14, 2019

(54) MODULAR PET WASTE SYSTEM

(71) Applicant: Zachary Norman, Venice, CA (US)

(72) Inventor: Zachary Norman, Venice, CA (US)

(21) Appl. No.: 15/705,231

(22) Filed: Sep. 14, 2017

(51) Int. Cl. A01K 1/01; A01K 1/015

(52) U.S. Cl. CPC A01K 1/0107; A01K 1/0152

(57) ABSTRACT

A modular pet waste system having a base filled with litter and a net placed over the litter to keep the litter from being kicked out by a pet. The net is held in the base by being sandwiched between two rims of the pet waste system. Various protrusions and recesses formed on sides of each base allow multiple bases to be connected to create larger surface areas for larger and/or multiple pets.

### CROSS REFERENCE TO RELATED APPLICATION

This application claims priority to U.S. Provisional Application No. 62/394,583, filed Sep. 14, 2016, which is hereby incorporated by reference as if fully recited herein. This application is also related to U.S. patent application Ser. No. 14/678,676, filed Apr. 3, 2015, published as U.S. Patent Publication No. 2016/0029589, and U.S. patent application Ser. No. 14/446,242, filed Jul. 29, 2014, published as U.S. Patent Publication No. 2015/0196004, which claims priority to U.S. Provisional Application No. 61/927,473, filed Jan. 15, 2014, all of which are hereby incorporated by reference in their entireties as if fully recited herein.

### BACKGROUND OF THE INVENTION

### Field of the Invention

The present invention generally relates to a pet waste system for use by household pets, such as dogs, for example. Pet owners have the responsibility of allowing the pet to relieve itself periodically. Oftentimes, the pet owner cannot let or take the pet outdoors, because the owner is simply not available to do so. Smaller pets, often found in apartments or generally smaller living spaces, need to relieve themselves more frequently, increasing the need for a convenient solution for them to relieve themselves as necessary.

### Description of the Related Art

U.S. Pat. No. 8,522,719, which is incorporated herein entirety by reference, relates to a portable, fully-disposable, pet toilet whose cavity is fitted with living grass, living sod, or a grass-seed medium. It has a fitted, removable cover or fold-back lid to enable the shipping and disposal of the unit in its entirely. This pet toilet, however, has a number of drawbacks, which are addressed by the invention disclosed herein.

Traditional litter boxes use a litter product that absorbs liquids. Often, this litter is in small particle form, allowing a user to scoop out “used” litter. While this may be suitable for cats, dogs often kick their hind legs after relieving themselves. In such instances, use of litter in small particle form is not suitable, as it would create a mess in the owner's home. Accordingly, there is a need for a system in which a dog would not disburse the litter in such a way.

Furthermore, there is a need for a system in which pet waste receptacles can be connected such that more surface area is created as may be needed in the case of larger breed dogs.

### BRIEF DESCRIPTION OF THE DRAWINGS

FIG. 1 illustrates an assembled view of the exemplary modular pet waste system with netting;

FIG. 2 illustrates an exploded view of the exemplary modular pet waste system with netting of FIG. 1;

FIG. 3 illustrates an assembled view of another embodiment of an exemplary modular pet waste system;

FIG. 4 illustrates an exploded view of the modular pet waste system of FIG. 3;

FIG. 5 illustrates an exploded view of another embodiment of an exemplary modular pet waste system;

FIG. 6 illustrates an exploded view of another embodiment of an exemplary modular pet waste system; and

FIG. 7 illustrates a partially-exploded view of another embodiment of an exemplary modular pet waste system.

### DETAILED DESCRIPTION OF THE DRAWINGS

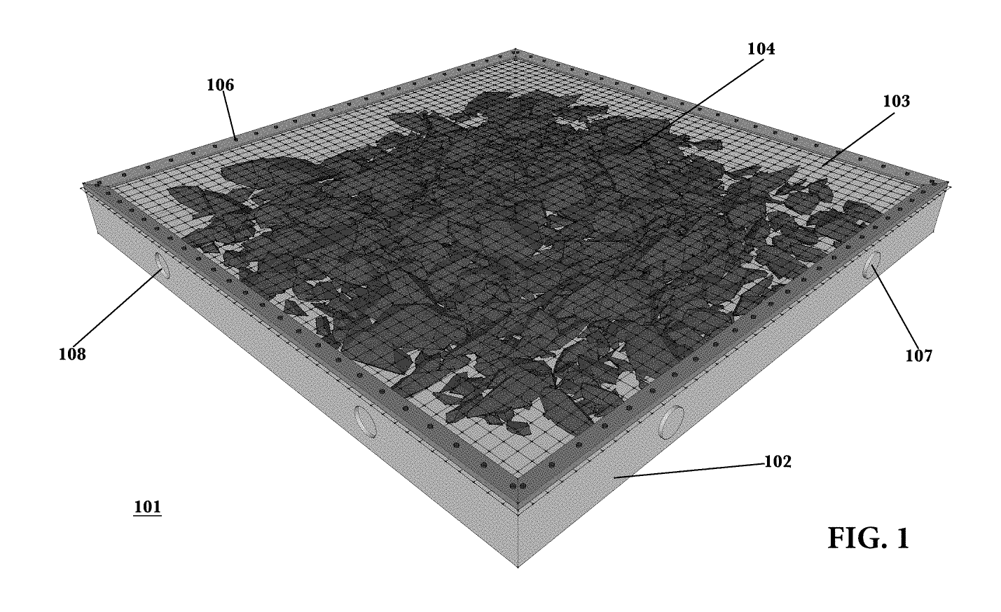

FIG. 1 illustrates an assembled view of the modular pet waste system with netting in accordance with one aspect of the present invention. The modular pet waste system with netting 101 generally comprises a base 102 generally in the form of a box, a netting 103 placed over the base, and litter 104 (bark, gorilla hair, or other suitable material) held within the base. Base 102 has four side and a bottom, to create a general box-like shape. While the exemplary embodiment is shown more square-like, base 102 can also be rectangular.

Each of the four sides of base 102 has a top, creating a contiguous rectangular top edge or rim 105. Along top edge or rim 105 of the box are small protrusions 106, such as pegs or teeth. Netting 103 can be placed over pegs 106 to allow the netting to be held across the opening or cavity formed in the base 102 and over the litter 104. The protrusions (pegs or teeth, etc.) may be pointed to allow the netting to be readily seated over the protrusions.

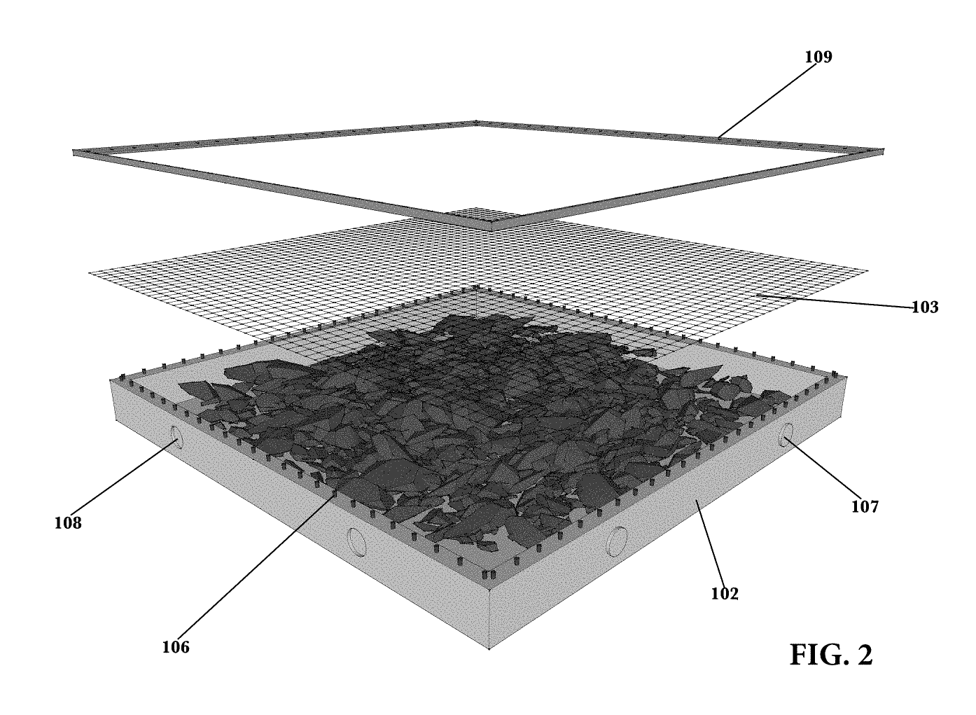

Base 102 has four side walls that extend from a bottom thereof. Formed on an outside of each of the four side walls are various protrusions 107 and recesses 108, which enable multiple base units to be removably joined. In the examples shown in FIGS. 1 and 2, these protrusions 107 and recesses 108 are shown to be circular, but can be a variety of shapes and sizes. Furthermore, in the example show in these figures, two protrusions or recesses are shown on each side, but there could be more or less. Once multiple modular receptacles are pushed together, the protrusions and recesses aid in preventing inadvertent disjoining. Moreover, any number of modular receptacles can be pushed together to create a variety of shapes and sizes to suit areas of differing shapes and sizes.

The base 102 may also further comprise an additional outer seal on each side wall to prevent fluids from leaking between modular bases when pushed together.

The base 102 can be made of a variety of materials but should be water tight to prevent fluid from leaking through the box. For example, the base may be a variety of water impermeable materials, such as plastic, or a cardboard (or other biodegradable material) material treated with a water impermeable sealant, such as wax.

FIG. 2 illustrates an exploded view of the modular pet waste system with netting of FIG. 1. In this view, the rim top element 109 can be seen. The rim top, while not required to keep netting 103 in place, can be used to further secure the net in place by sandwiching the netting 103 between the rim top and top edge or rim. The rim top may also be angled toward an inside of the base to allow fluid to flow into the box, rather than outside the box.

The rim top 109 is helpful in allowing the user to remove the rim top and replace the netting. A user can thereby reuse the base receptacle, only replacing the litter, as needed, and even the netting, as needed.

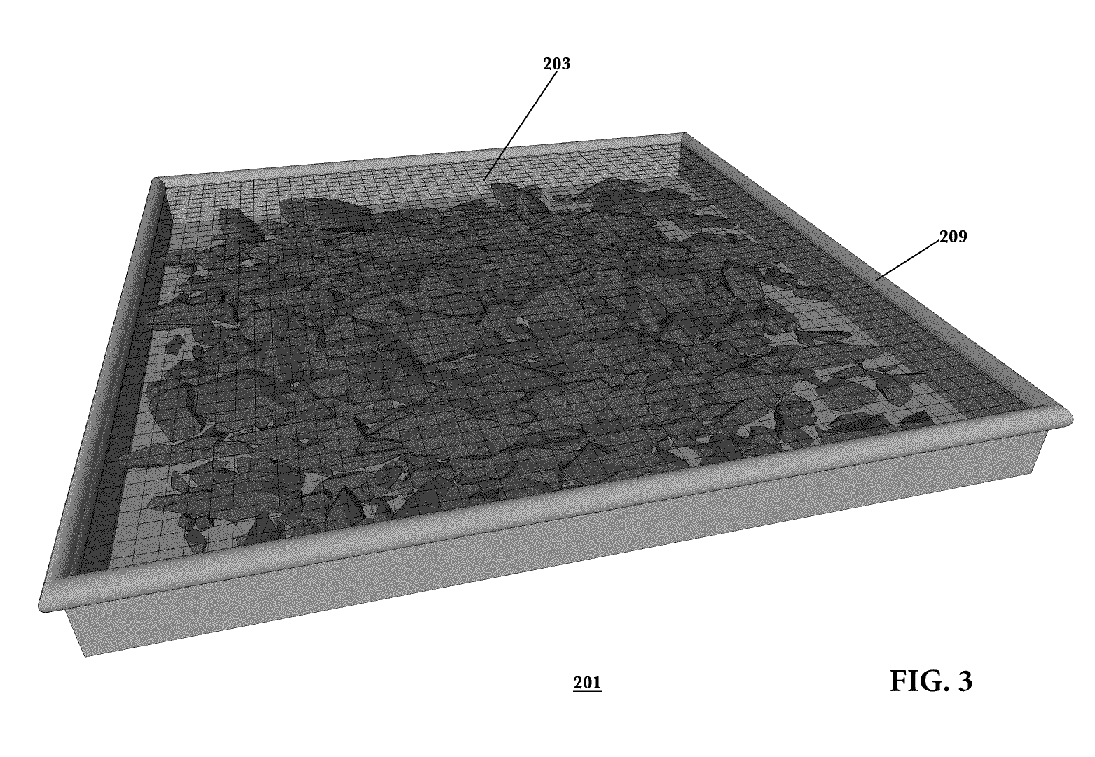

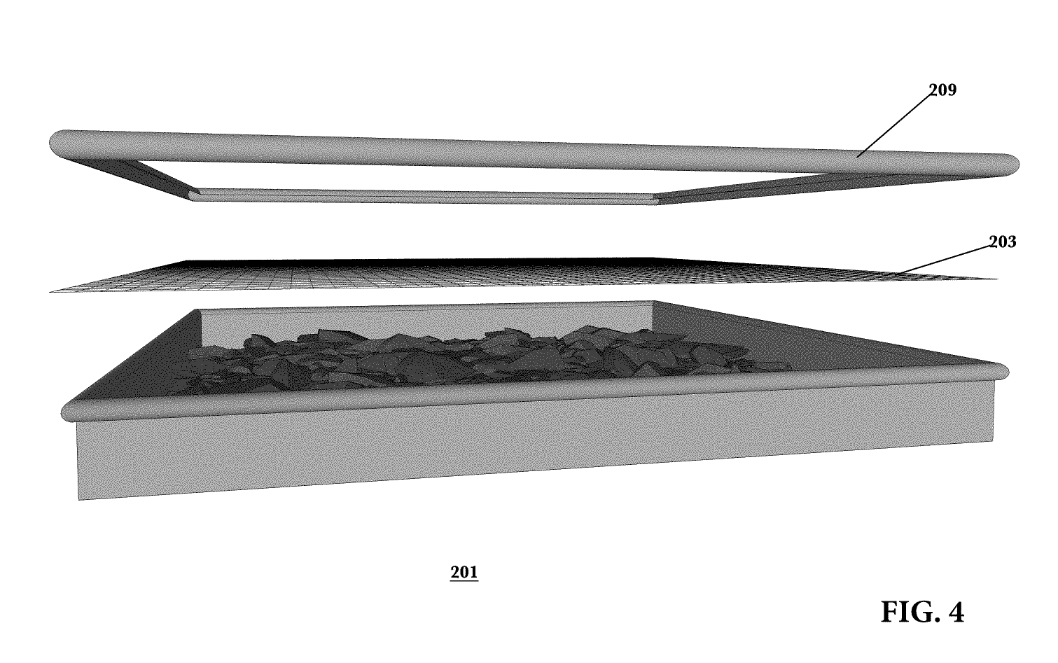

When a top rim is used, protrusions (pegs or teeth, etc.) may be omitted if the top rim is able to sandwich the net to hold the net in place as can be seen in FIGS. 3 and 4. In this exemplary embodiment 201, the top rim 209 is placed over the net 203, sandwiching the net 203 between the top rim and protruding rim formed on top sides of the receptacle. The addition of the rim also adds structure and rigidity to the system.

Other types of other fastening systems may be used without departing from the general scope of the invention. For example, a single fastening peg may be added to each corner to allow the top rim to snap into place. Other types of (non-peg) fasteners may be used to secure the top rim onto the base, for example.

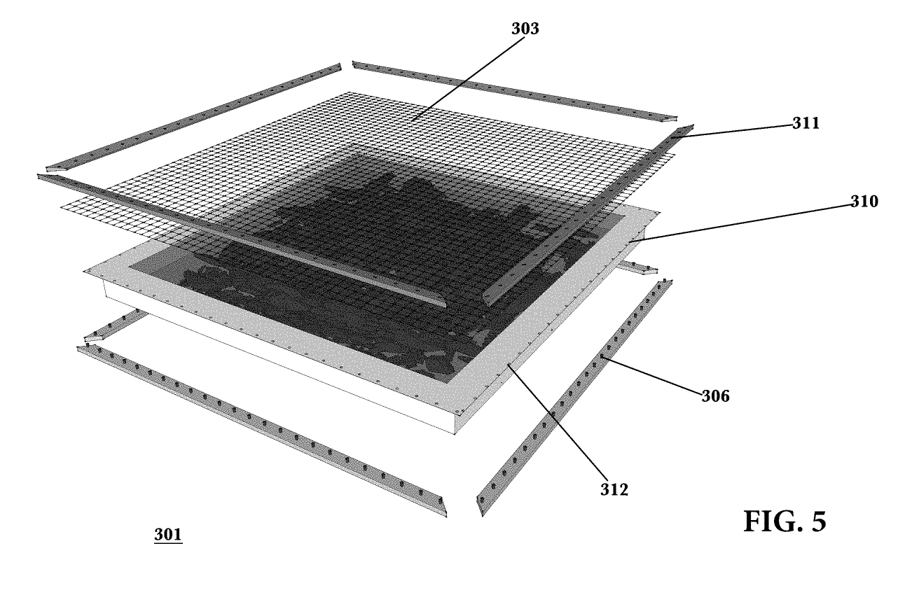

FIG. 5 shows another exemplary system 301 in which netting 303 is secured using a peg and hole system. In this example, a flange 310 is created along a top edge of the receptacle, which flange is sandwiched, along with the netting, between a set of rims lined with mating pegs 306 and/or holes 311. Flange 310 also has a series of holes 312 to allow pegs 306 to pass therethrough.

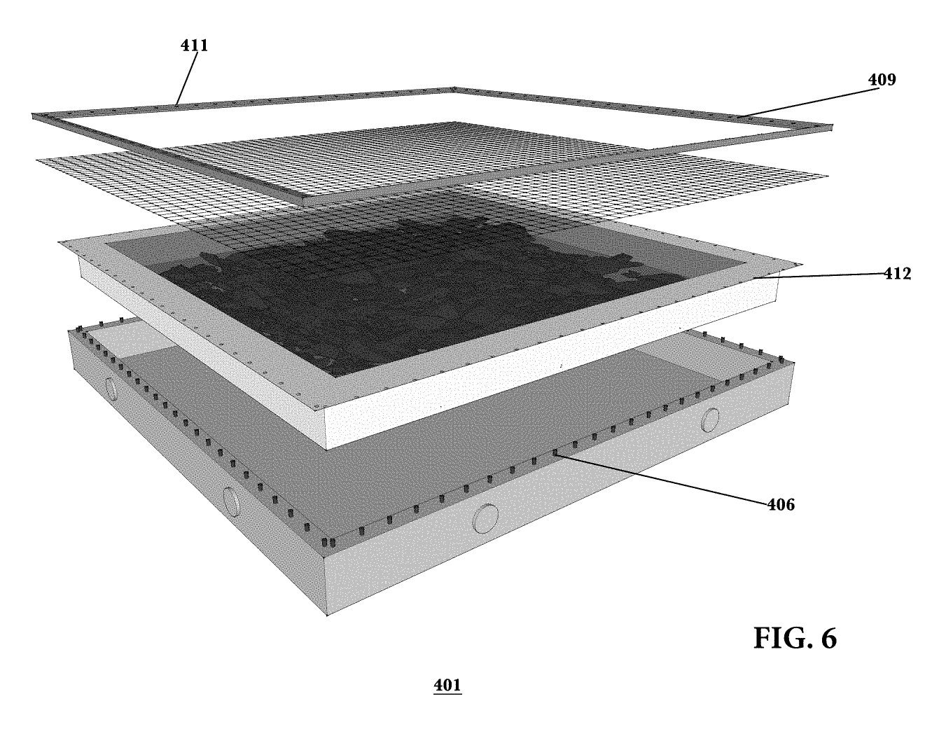

FIG. 6 shows an example of a separate container being held in the receptacle. As can be seen in this figure, pegs 406 are provided along an upper rim of the receptacle. Holes 412 are provided along a flanged rim of the container holding the litter. A top rim 409, also with holes 411, is provided over the netting to secure the netting onto the container. While not shown in this particular example, the pegs could also be provided along the top rim and the holes could be provided on the receptacle without departing from the general scope of the invention.

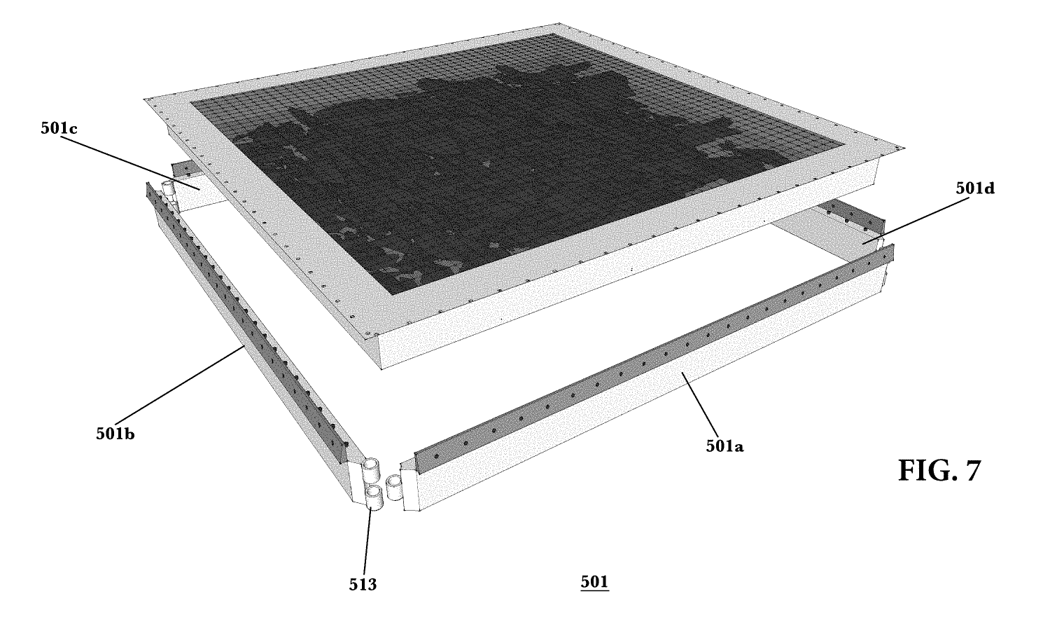

FIG. 7 shows an example of a container system with four separate side walls 501a-d. The four side walls can be connected together in a hinge-like fashion with a knuckle 513 and pin (not shown). Each side wall further has a hinging section formed along the top of each side wall. The top of each side wall is lined with pins and the hinging section is lined with holes. The container, which has holes along its rim, fits between the top of each side wall and hinging section. The four side walls are such that they can be assembled and/or disassembled by a user.

In any of the exemplary embodiments, the systems can come pre-assembled prior to delivery to the user or the systems can come such that the litter, the container, and the netting, or any combination thereof, can be individually replaced by the user. For example, in FIG. 7, the container, netting and litter can be delivered on a scheduled basis as a unit and replaced by a user within the reusable receptacle.

An attractant can be used with the litter to encourage the dog to use the receptacle. The attractant can be synthetic or natural. The attractant can either be or simulate urine odor (or other odor to encourage the dog to use the litter). The attractant can be in the form of a spray, and it can be disposed in or on the litter or receptacle prior to shipping and delivery. The litter may also be soaked in the attractant prior to shipping and delivery. The attractant can also be shipped inside the receptacle in a separate container to be applied by the user. The attractant can also be delivered separately to be applied by the user. A separate attractant can allow the user to “activate” the litter upon receipt, increasing shelf stability.

While the foregoing written description of the invention enables one of ordinary skill in the art to make and use the invention, those of ordinary skill in the art will understand and appreciate the existence of variations, combination, and equivalents of the embodiments, methods, and examples provided herein. The invention should, therefore, not be limited by the embodiments and examples disclosed here, but by all embodiments and methods within the scope and spirit of the invention as claimed.

We claim:

1. A modular pet waste system comprising:
a base having a bottom and four side walls extending from said bottom creating a cavity, each of said four side walls having a top, said tops of each of said four side walls creating a first rim;
litter provided in said cavity formed in said base;
a plurality of pegs provided along said rim; and
a netting provided over said plurality of pegs to cover said cavity.

2. The modular pet waste system of claim 1, wherein a second rim is provided over said first rim to further secure said netting.

3. The modular pet waste system of claim 2, wherein said second rim mimics the shape and size of said first rim.

4. The modular pet wet system of claim 1, wherein two of said four side walls have protrusions and two of said four side walls have recesses, wherein the shape of said protrusions mimics the shape of said recesses.

5. A modular pet waste system comprising:
a base having a bottom and four side walls extending from said bottom creating a cavity, each of said four side walls having a top, said tops of each of said four side walls creating a first rim;
litter provided in said cavity formed in said base;
a netting provided over said plurality of pegs to cover said cavity; and
a second rim provided over said first rim to secure said netting in between said first and second rims and over said litter.

6. The modular pet waste system of claim 5, wherein said second rim mimics the shape and size of said first rim.

7. The modular pet wet system of claim 5, wherein two of said four side walls have protrusions and two of said four side walls have recesses, wherein the shape of said protrusions mimics the shape of said recesses.
